(19) United States
(12) Patent Application Publication
(10) Pub. No.: US 2021/0114730 A1
(43) Pub. Date: Apr. 22, 2021

(54) AUTONOMOUS AERIAL VEHICLE WITH A FENDER CAGE ROTATABLE IN EVERY SPHERICAL DIRECTION

(71) Applicant: Andrew Norman MACDONALD, Stockport (GB)

(72) Inventor: Andrew Norman MACDONALD, Stockport (GB)

(21) Appl. No.: 17/256,172

(22) PCT Filed: Jun. 27, 2019
(86) PCT No.: PCT/GB19/51814

§ 371 Date: Dec. 24, 2020

(30) Foreign Application Priority Data
Jun. 27, 2018 (GB) 1810554.4
Jan. 28, 2019 (GB) 1901091.7

(51) Int. Cl. B64C 39/02; F16C 19/10

(52) U.S. Cl. CPC B64C 39/024; B64C 2201/027; F16C 19/10

(57) ABSTRACT

An unmanned aerial vehicle has a thrust body including a control system, thrusters to generate lift and direct the UAV in response to control signals from the control system. A spherical fender cage envelopes the thrust body. Spokes extend radially from the thrust body to support spherical thrust bearings able to slide freely against the internal spherical surface of the fender cage such that the fender cage is uncoupled from the thrust body and can rotate freely in any spherical direction without the use of any gimbal mechanism.

### TECHNICAL FIELD

The invention concerns an autonomous aerial vehicle capable of moving along the ground and able to fly. An autonomous aerial vehicle will most commonly be an unmanned aerial vehicle but may have an onboard pilot or a passenger.

The autonomous aerial vehicle has a thrust body provided with thrusters. The thrusters will usually be provided by one or more rotors (eg., propellers or ducted fans) powered by one or more motors. Commonly each rotor is powered independently by a motor and controlled by an intelligent microprocessor controller. Usually the axis of the rotor thruster is disposed on, or parallel to, a notional vertical axis of the autonomous aerial vehicle. The autonomous aerial vehicle will lift vertically when the thrust generated by the, or each, thruster is aligned with a world vertical. To generate lateral thrust the thrust of one or more rotors is altered so that the thrust body vertical axis pitches, rolls or yaws. Thrusters may be provided by alternative moving wing thrusters such as an ornithopter or non-wing thrusters such as jets or rockets.

To allow the autonomous aerial vehicle to move along a nominally horizontal surface, such as the ground, an overlying surface such as a ceiling or against a vertical surface such as a wall the autonomous aerial vehicle has a generally spherical fender cage surrounding the thrust body supported to rotate in several spherical directions, that is to say directions tangential to the surface of the sphere.

### PRIOR ART

The closest known prior art fender caged autonomous aerial vehicle is exemplified by a EP2813428 and EP3024726 although there are several other examples of fender caged AAVs. EP2813428 provides a thrust body connected to a generally spherical cage by two radial spokes each extending diametrically from the thrust body. Each spoke connects to an inner gimbal ring by a first axially rotatable spoke bearing to allow the inner gimbal ring to rotate around a first spoke axis. An outer gimbal ring is connected by rotary outer gimbal ring bearings to the inner gimbal ring, at positions spaced circumferentially (90 degrees) from the spoke bearings. This allows the outer gimbal ring to rotate around the inner gimbal ring on an axis of rotation 90 degrees from the spoke axis. A generally spherical fender cage is connected to the outer gimbal ring by rotary cage bearings located equi-spaced from the outer gimbal ring bearings allowing the cage to rotate around the thrust body on any or each of three axis fixed by the gimbal rings to be mutually perpendicular. Thus if the cage impinges on another object such as the ground any rotation induced in the cage is not ordinarily communicated to the thrust body. The cage thus allows the autonomous aerial vehicle to move along a surface in a controlled way and the surface is protected from impact with the rotors and vice versa. In the first embodiment illustrated in EP2813428 the cage is fabricated from three mutually perpendicular gimbal rings rigidly connected together. The second embodiment shows a cage formed from rigid spars of similar length joined as hexagons surrounding pentagons to form a Fuller sphere.

A problem with the of autonomous aerial vehicle of EP2813428 is that the cage is voluminous, especially where it envelopes a larger thrust body capable of carrying a larger payload. This makes transporting the autonomous aerial vehicle a challenge and may make the autonomous aerial vehicle fender cage more vulnerable to damage in transit. The fender cage makes access to the thrust body difficult, especially where the Fuller sphere structure is used so that tending to payload or battery power pack exchange or charge becomes difficult.

A further disadvantage of the autonomous aerial vehicle of EP2813428 and EP3024726 is that the gimbal rings and associated bearings add weight to the autonomous aerial vehicle adversely affecting payload and endurance. A further disadvantage of the autonomous aerial vehicle of EP2813428 and EP3024726 is that the gimbal rings and bearings add to the number of components and therefore the number of assembly steps and consequent costs of the autonomous aerial vehicle.

The junction of the gimbal rings, bearings and spokes are relatively vulnerable to damage and fouling.

A further technical problem common to all gimballed devices is known as gimbal lock. Gimbal lock occurs if two or more axis of rotation align, in effect reducing the available axis of rotation from two to one. If the fender cage is subject to a force not tangential to the available axis of rotation, the cage cannot isolate the lifting body and the force will be communicated to the lifting body.

### SUMMARY OF INVENTION

According to a first aspect of the present invention there is provided an autonomous aerial vehicle having:

a thrust body;
spokes extending radially from the thrust body to deploy convex spherical bearing surfaces provided by thrust bearings at a common radius from the thrust body; and a fender cage having a spherical inner bearing surface with a radius equal to the common radius whereby the fender cage is supported, by engagement between the thrust bearings and the inner surface of the fender cage, at a fixed distance from the thrust body and the fender cage can rotate in every spherical direction around the thrust body.

For the purposes of this specification the term spherical direction means any direction tangential to the surface of a sphere.

The fender cage is provided either by a plurality of elongate members shaped to envelope a spherical surface leaving numerous passageways for airflow or a hollow spherical structure perforated by numerous passageways to permit minimally inhibited airflow. The thrust bearing presents a spherical bearing surface which spans the passageways to engage with the inner bearing surface of the fender cage in every configuration of the fender cage. Thus the thrust bearing cannot fall into or otherwise be trapped at any point of engagement with the fender cage. Unlike a gimballed system there is no possibility of two or more axis of rotation aligning and so gimbal lock is impossible.

To facilitate assembly, disassembly and maintenance the fender cage may be fabricated to separate into two generally similar hemispherical parts, which may be at least partially nested to compact the cage storage and transportation. The two hemispherical parts may be separably joined by an equatorial band.

An unexpected benefit of the aerial vehicle is that it discourages persistent spinning of the fender cage, a phenomenon known from the prior art fender cage.

According to a second aspect of the present invention there is provided an autonomous aerial vehicle comprising a thrust body supporting a fender cage, wherein the fender cage comprises elements which in a deployed condition extend over a notional surface enveloping the thrust body, said fender cage being constructed to be reversibly compactible for packaging, transport and access to the thrust body.

Preferably the fender cage of the second embodiment is formed from a pair of rigid hollow hemispherical bodies adapted to be joined at their rims to form a hollow sphere around the thrust body. A fender cage support assembly comprises at least a pair of spokes extend from the thrust body to the inner spherical surface of the fender cage where the spokes support spherical thrust bearings engaging directly with the inner surface of the fender cage. The thrust bearings allow the fender cage to rotate freely in any spherical direction about the centre of the spherical fender cage because there is no fixed point of attachment or contact between the thrust bearing and the fender cage.

The effective diameter of the spokes may be fixed to suspend the thrust body generally at the centre of the spherical fender cage. However, the spokes and or thrust bearings may be resiliently deformable to permit limited relative movement of the thrust body and fender cage. Resilient deformation may be provided by a spoke with a telescopic structure urged by spring means to a neutral condition. Alternatively the spoke may be formed with integral spring structural features.

The thrust bearings may mount onto the ends of the spokes by means of an axial sleeve which slides onto a spindle formation on the end of the spoke. A tight sliding fit, or snap engaging structure, may be used to retain the thrust bearing but facilitate removal for repair and replacement in the event of damage.

The thrust body defines a flat plane perpendicular to the thrust axis of the or each thruster. Commonly the thrust axis is also the axis of rotation of the or each rotor and this specification should be understood accordingly. In one preferred vertical spoke embodiment of the autonomous aerial vehicle the spokes extend from the thrust body parallel to the thrust axis. In an alternative lateral spoke embodiment the spokes extend parallel to the flat plane. The length and point of connection of the spokes and the thrust body is preferably arranged so that the centre of mass of the thrust body normally sits above or below the centre of the fender cage when the autonomous aerial vehicle is configured for flight (ie the power pack and payload such as cameras is attached). In some embodiments of the autonomous aerial vehicle the connection to the thrust body and thrust bearing is rigid so that the thrust bearing cannot rotate relative to the thrust body. In some embodiments of the autonomous aerial vehicle the connection between the thrust body and the spokes is a rotary bearing allowing each spoke to rotate around its long axis.

Each thrust bearing may be provided with friction reducing elements to engage the interior bearing surface of the fender cage. Friction reducing elements may be pads of low friction material such as PTFE. Friction reducing elements may be pads of foam or felt wetted with lubricating agents such as oil. Friction reducing elements may also comprise structures supporting rolling elements where the rolling elements engage the interior bearing surface of the fender cage. Rolling elements may consist of balls or rollers. For example, ball bearings may be retained in correspondingly shaped recesses formed in the fender cage facing surface of the thrust bearing.

In a preferred embodiment each thrust bearing may consist of a cage or chassis supporting one or more rollers for rotation around an axis extending tangential to the spoke axis. The surface of each roller engages the interior surfaces of the fender cage. Because the rollers are free to rotate the fender cage is free to rotate in any direction around its centre. The rollers accommodate any permanent or transient irregularity in the interior surface of the fender cage. Such irregularities may be caused by impacts with external structures which deform the fender cage. The fender cage can thus be kept sufficiently stiff without incurring an excessive weight penalty.

In a preferred embodiment the thrust bearing comprises a cage having sides generally resembling a regular polygon. The minimum number of sides will be three (a triangle) however, a quadrilateral, pentagon, hexagon, heptagon and most preferably an octagon are all possible.

Preferably the rollers have tapered surfaces extending from a maximum diameter at the centre to a minimum diameter at the axial ends. More preferably the taper is a spherical taper such that a cross section of the roller reveals an arcuate surface, preferably a spherical arcuate surface.

According to a third aspect of the present invention there is provided an autonomous aerial vehicle comprising a thrust body supporting a fender cage, wherein the fender cage comprises elements which in a deployed condition extend over a notional surface enveloping the thrust body, said fender cage being constructed to reversibly compact down to a more compact configuration for packaging and transport and to unfold to a deployed configuration.

The fender cage is preferably supported to be freely rotatable with respect to the thrust body about at least two mutually perpendicular axes.

The fender cage, when deployed for use, is preferably generally spherical to facilitate rolling motion in any direction.

The in a first embodiment the fender cage elements may comprise a pair of diametrically spaced hubs and a plurality of arcuate spars secured to and extending between each hub. The end of each spar may engage in each hub via a pivotable anchor. The anchor may be provided by a circular pin. The anchor of each spar is disposed such that it is radially spaced from a centre of each hub and circumferentially spaced from each other anchor attached to the hub. Conveniently the hub may have a locking means to lock each spar into a position extending radially from the hub to achieve the deployed condition. The locking means may be a machine screw. The hub may comprise an inner annular disc and an outer annular disc, said inner annular disc having a central hole threaded to receive the machine screw, each of the inner and outer discs having a facing surface formed with radially extending grooves to receive the end of each spar and an annulus of circumferentially spaced holes to capture the pin whereby tightening the machine screw locks the position of the spar ends radially, one in each groove and loosening the machine screw allows the spars to pivot to a compacted condition.

The fender cage elements preferably include at least one circular strut removably securable to each spar. The strut may be secured to each spar by means of pins formed on one of the strut or the spar and arranged to be received into pin holes formed on the struts.

The autonomous vehicle can have an outer ring rotatable about at least one axis of the thrust body, said outer ring supporting two trunnions extending diametrically out from the outer ring, said machine screws each having an axial bore to receive the trunnions and attach the fender cage to the autonomous vehicle to be rotatable around the axis of the trunnions. The outer ring may provide a ring track channel and an inner ring engages the outer ring by means of a roller projecting radially out from the inner ring to engage in the outer ring channel whereby the fender cage can rotate around at least a second axis. Preferably a suspension beam extends diametrically from the thrust body so that the opposite ends of the suspension beam engage the inner ring by means of rotary bearings whereby the inner ring is freely rotatable about a third axis.

### BRIEF DESCRIPTION OF FIGURES

Embodiments of an autonomous vehicle with a compactible fender cage, rotatable about at least two perpendicular axes, constructed in accordance with the present invention, will now be described, by way of example only, with reference to the accompanying illustrative figures; in which,

FIG. 1.1 is a SE isometric view of the autonomous vehicle with the fender cage in the deployed configuration;

FIG. 1.2 is a SE isometric view of the autonomous vehicle partially prepared to fold up the fender cage;

FIG. 1.3 is a SE isometric view of the autonomous vehicle with the fender cage folded up compacted configuration;

FIG. 1.4 is a SE isometric view of a spar of the fender cage;

FIG. 1.5 is a sectional front elevation of the autonomous vehicle with spars and struts of the fender cage removed;

FIG. 1.6 is a sectional left elevation of the autonomous vehicle with spars and struts of the fender cage removed;

FIG. 2.1 is a plan view of a second embodiment of the autonomous aerial vehicle;

FIG. 2.2 is a front elevation of the second embodiment;

FIG. 2.3 is a sectional elevation on the line 2.3-2.3 in FIG. 2.1;

FIG. 2.4 is a sectional elevation on the line 2.4-2.4 in FIG. 2.2;

FIG. 2.3.1 is an enlarged detail front sectional view from FIG. 2.3;

FIG. 2.5 is a SE isometric view of a thrust body and fender cage support means;

FIG. 2.5.1 is a SE isometric detail of a clamp assembly securing a spoke of the fender cage support assembly to the thrust body;

FIG. 2.5.2 is a SE isometric view of the coupling between a spoke of the fender cage support assembly and a thrust bearing of the fender cage support assembly

FIG. 3.1 is an isometric SW view of a third embodiment;

FIG. 3.2 is a plan view of the third embodiment;

FIG. 3.3 is an isometric SW view of the third embodiment showing an upper part of a fender cage removed;

FIG. 3.4 is an enlarged isometric SW view of the third embodiment with the fender cage, a lifting body and roller bearings removed; and

FIG. 3.5 is a sectional view through a spoke and thrust bearing.

### DETAILED DESCRIPTION OF FIGURES

It should be noted that references to horizontal and vertical refer only to the orientation of the UAV as shown in the figures, it will be obvious that in use the UAV can take up other orientations.

### First Embodiment

The autonomous vehicle shown in the figures comprises a thrust body indicated generally by arrow 1 supporting a fender cage indicated generally by arrow 2. The thrust body 1 has a chassis 3 supporting a battery of power cells arranged to power each of four thrusters provided by motors 4 arranged to spin four rotors 5. In every embodiment the thrust body includes an autonomous controller and remote control transponder, as is known to the person skilled in the art, to independently control the speed of the motors and so to effect roll, pitch and yaw in order to direct the thrust of the rotors in response to a control signal received from a remote manually operable remote control. The remote control may be a dedicated device or a general purpose control device with wireless communications capability such as a cell phone. The techniques for such control are common general knowledge in the technical field.

The thruster body 1 is suspended from a suspension beam 6 which extends equidistantly from the thrust body in each direction along or parallel to a Y-axis of the autonomous vehicle to terminate in a rotary rolling element bearing 7 secured into a bearing housing 8. The bearing housing 8 is formed into an inner ring 9 which encircles the thrust body 1.

The inner ring 9 supports a pair of radially outwardly facing rollers 10 each spaced 90° from the bearing housing 8. the roller 10 is supported on an axle 11 by rolling elements. The roller engages in a channel section outer ring 12 so that the inner ring can freely rotate within the outer ring and provide for rotation around the “Z-axis” of the thrust body 1.

The outer ring 12 supports a pair of diametrically outwardly extending trunnions 13.

Each trunnion 13 supports a hub assembly. Each hub assembly comprises an inner hub disc 14 an outer hub disc 15 and a machine screw 16. Each hub disc has a central hole sized to receive the machine screw 15. The central hole 15.1 of the outer hub disc 15 is a through hole while the inner hole 14.1 of the inner disc 14 is a threaded hole. Six grooves 14.2 and 15.2 extend radially out from an annulus of each of the inner and outer discs and on facing surfaces of the discs. I ring of six axially extending holes 14.3 and 15.3 is formed in each of the inner and outer discs with similar circumferential and radial spacing.

The fender cage 2 is formed from six spars 17. Each spar 17 is formed pre-bent into an arcuate form. Each end of each spar 17 is formed with a cylindrical pin 18 which extends along a chord of the arc of the spar 17 to be receivable one each into the pin holes 14.3 and 15.3 to trap the ends of the spars between the inner and outer hub discs. The hub discs 14 and 15 of each hub assembly may be closed together by aligning each spar into one of the pairs of grooves 14.2 and 15.2 and tightening the machine screw 16 in the thread of the inner hub disc 14. The Machine screw 16 is formed with an axial bore 16.1 in its shaft adapted to receive the trunnion 13. Thus the fender cage 2 is held onto the outer ring by the resilience of the spars which prevent the machine screw 16 from coming off the trunnion 13.

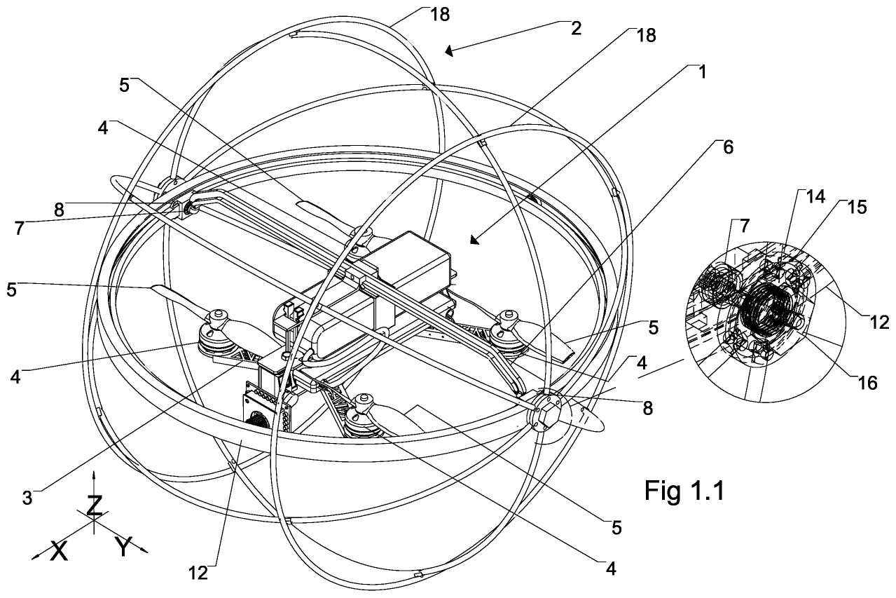

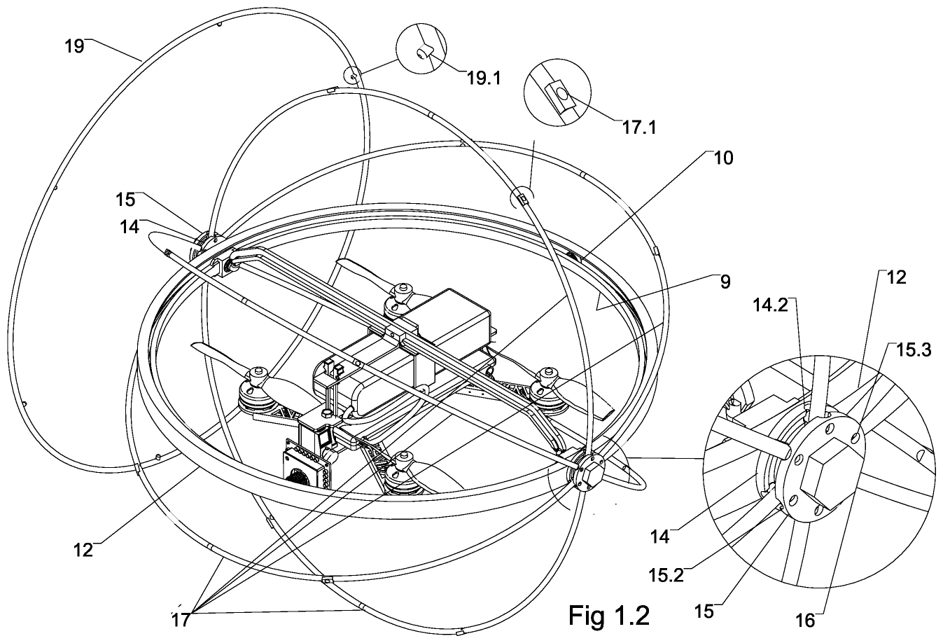

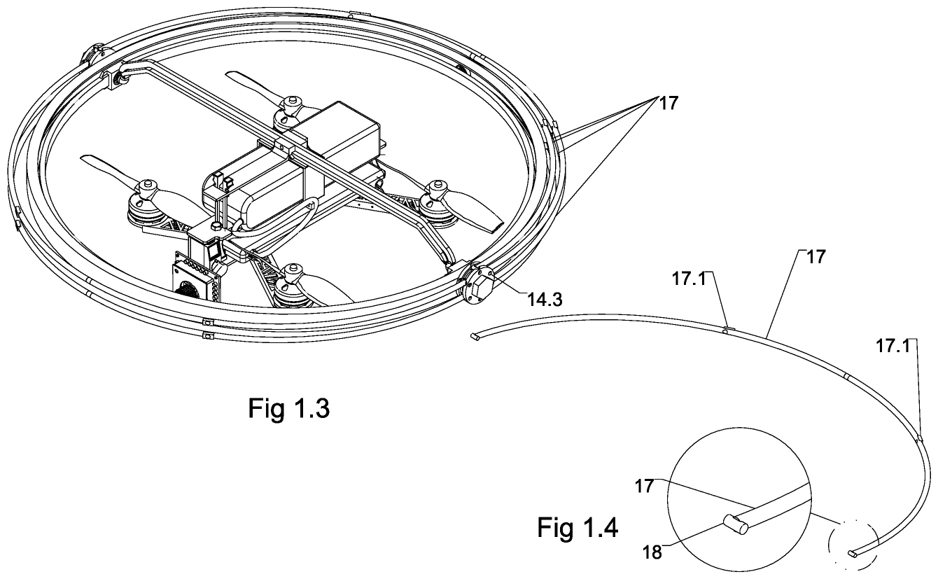

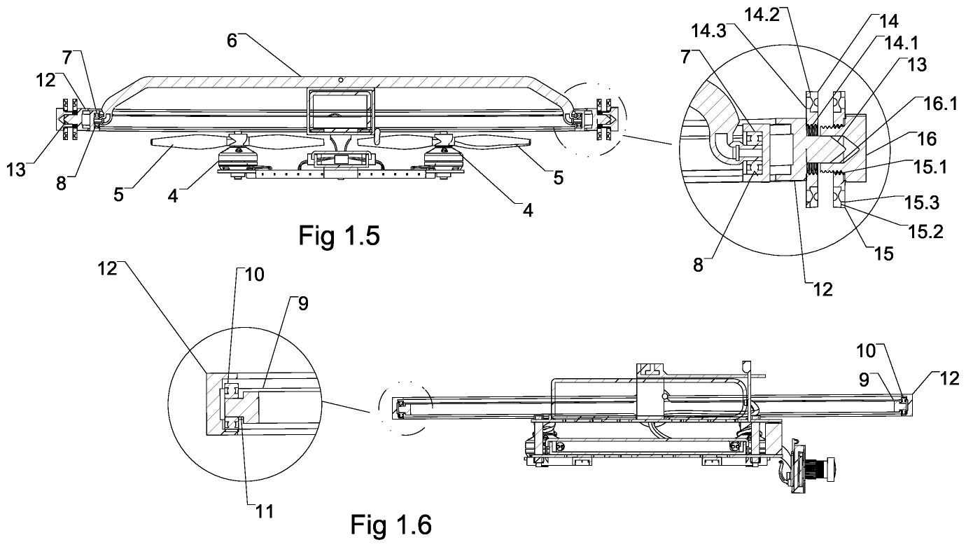

When deployed the fender cage is reinforced by two circular struts 19. The circular struts 19 have six inwardly facing pins 19.1 at regular circumferential spacings. Each pin 19.1 is disposed to engage in one of two spar pin holes 17.1 formed in each of the spars 17 to form the assembled fender cage shown in FIG. 1.1.

To fold the fender cage 2 the machine screw 16 is at least partially unscrewed as shown in FIG. 1.2 particularly the detail of the hub assembly. Each spar pin 18 is sufficiently long to remain trapped in its respective hole 14.3, 15.3 but is free to move out of the radial grooves 14.2 and 15.2 so that it can be pivoted to the condition shown in FIG. 1.3. Deploying the cage for use is the reverse operation.

The autonomous vehicle is capable of rolling along the ground, walls or ceilings in any direction without the movement of the cage applying torque to the thrust body. The autonomous vehicle will also be capable of flight.

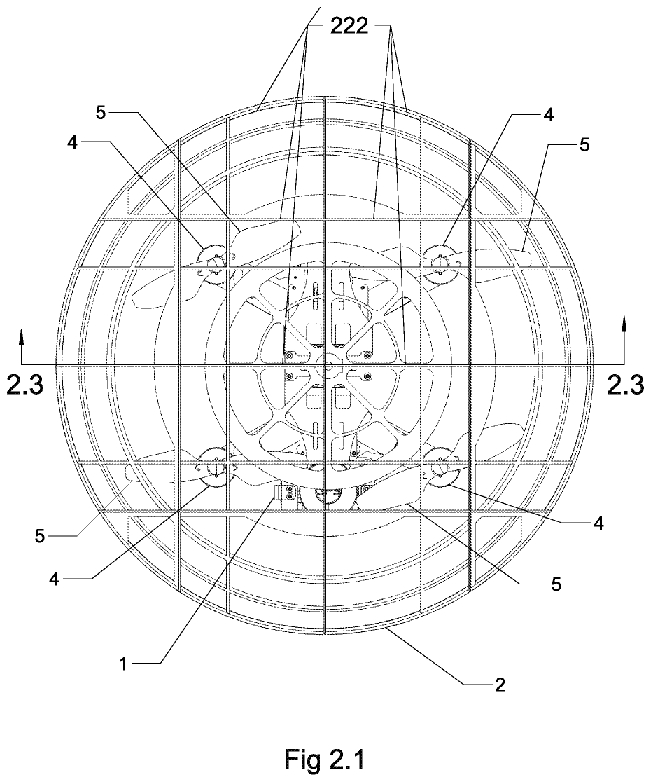

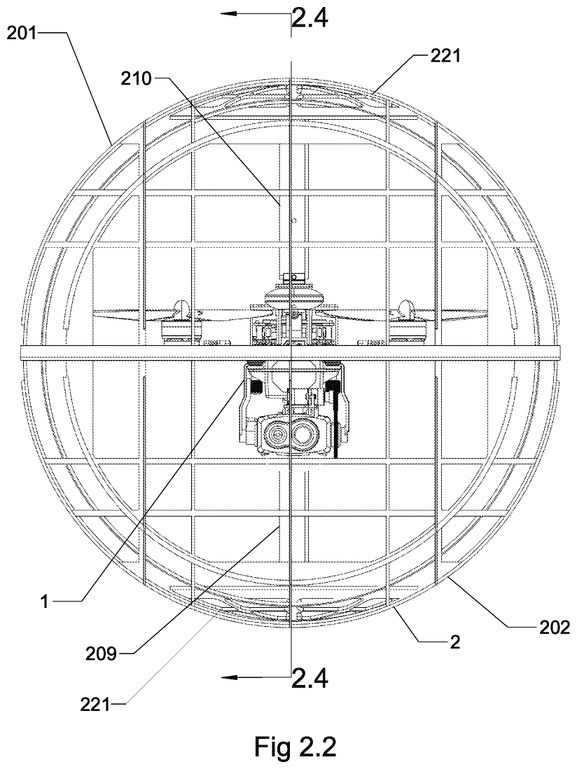

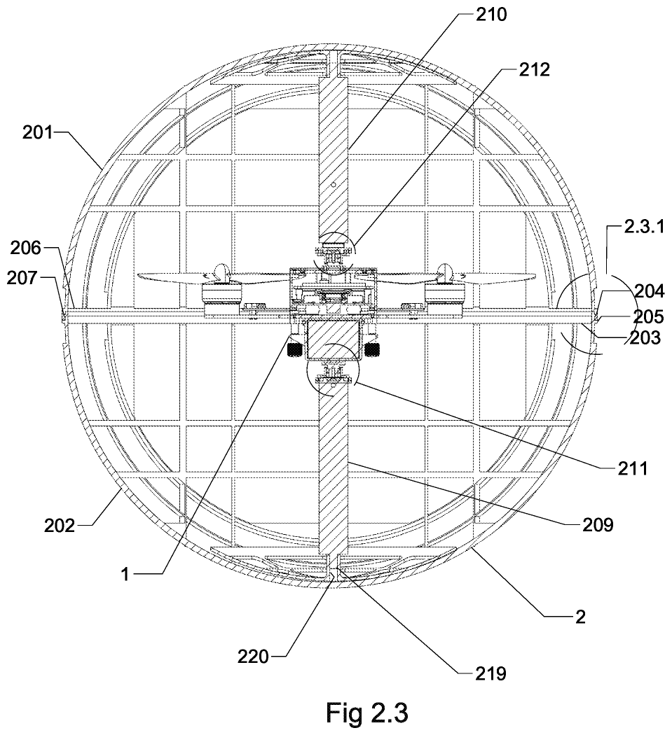

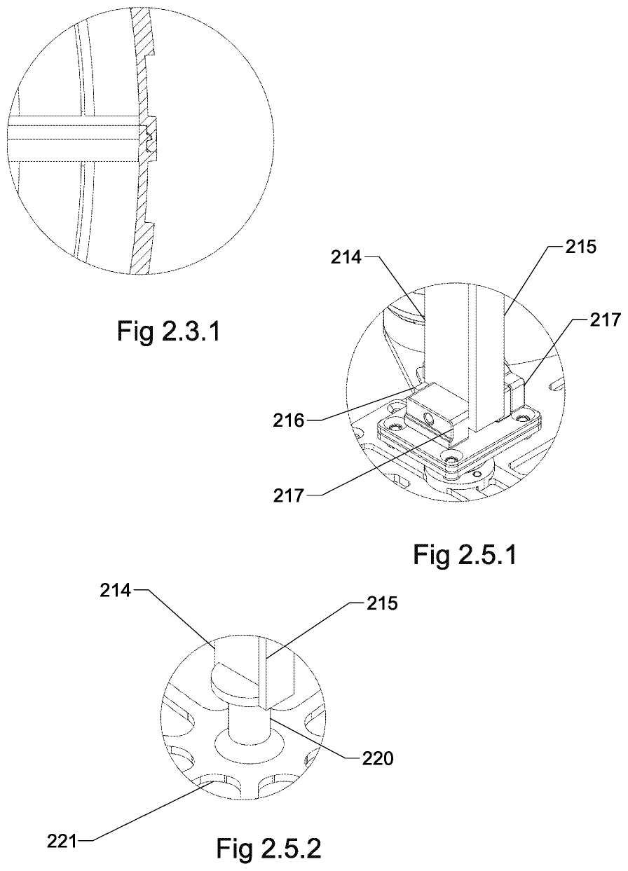

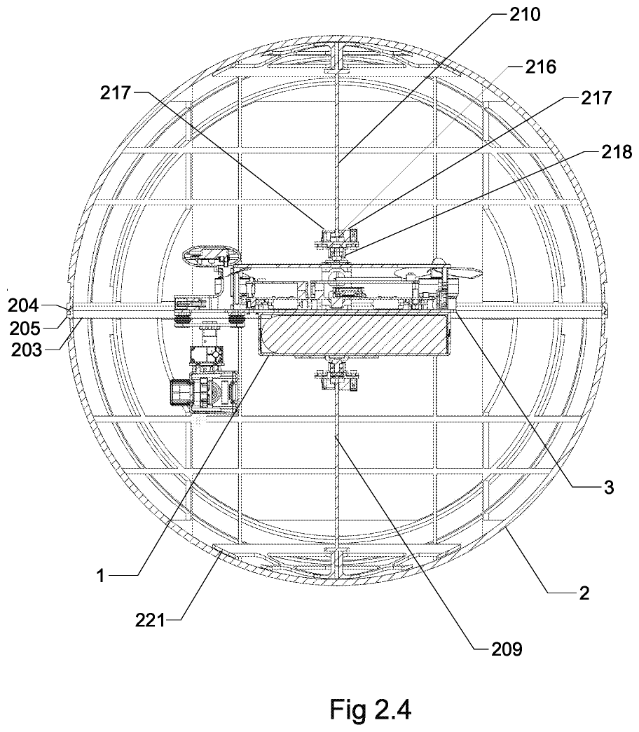

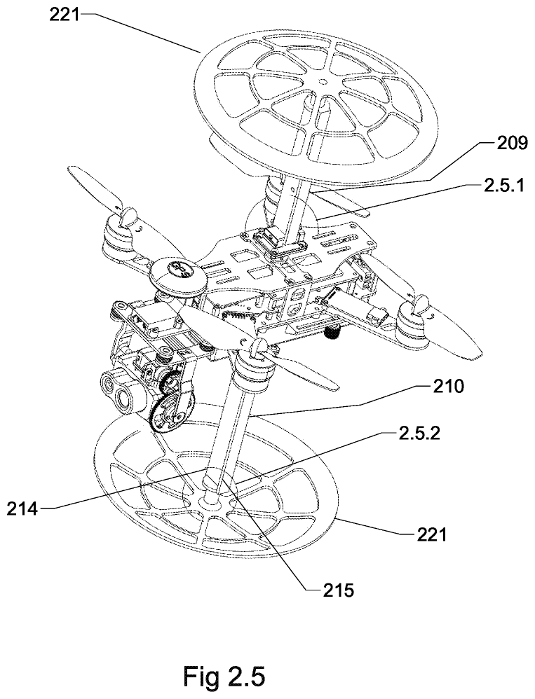

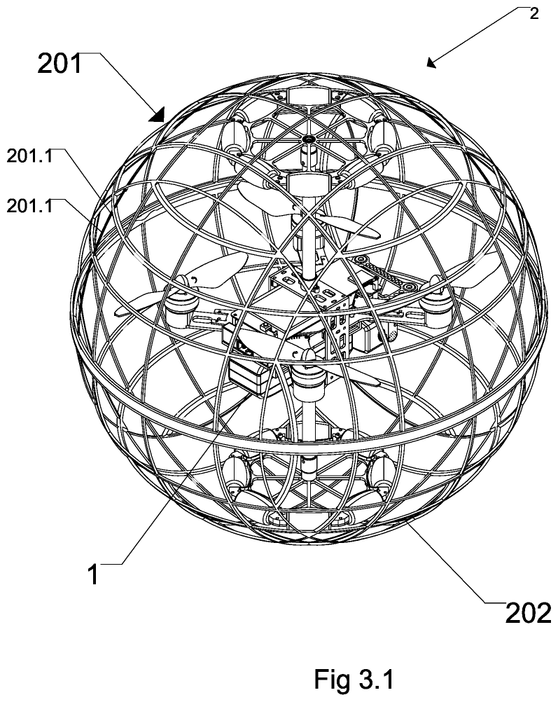

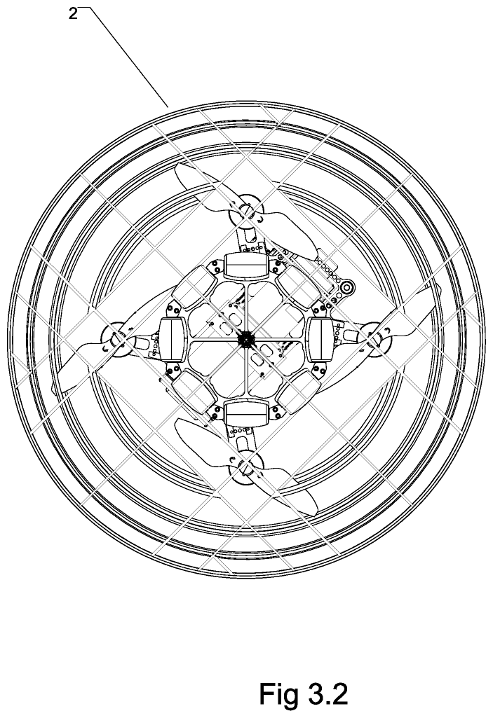

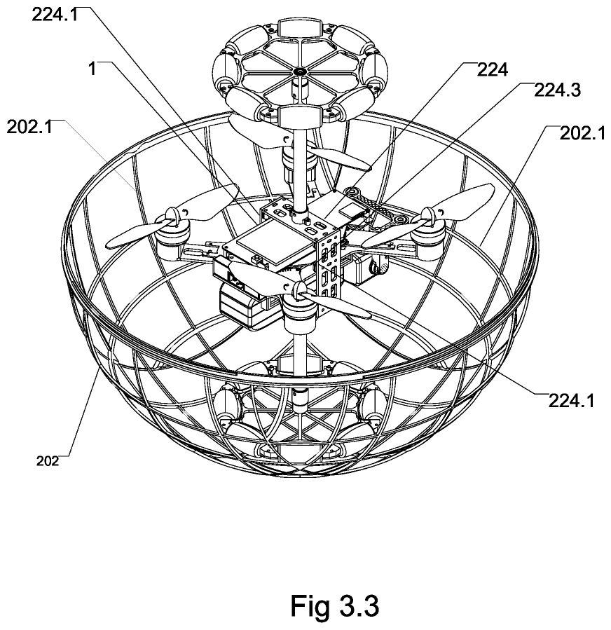

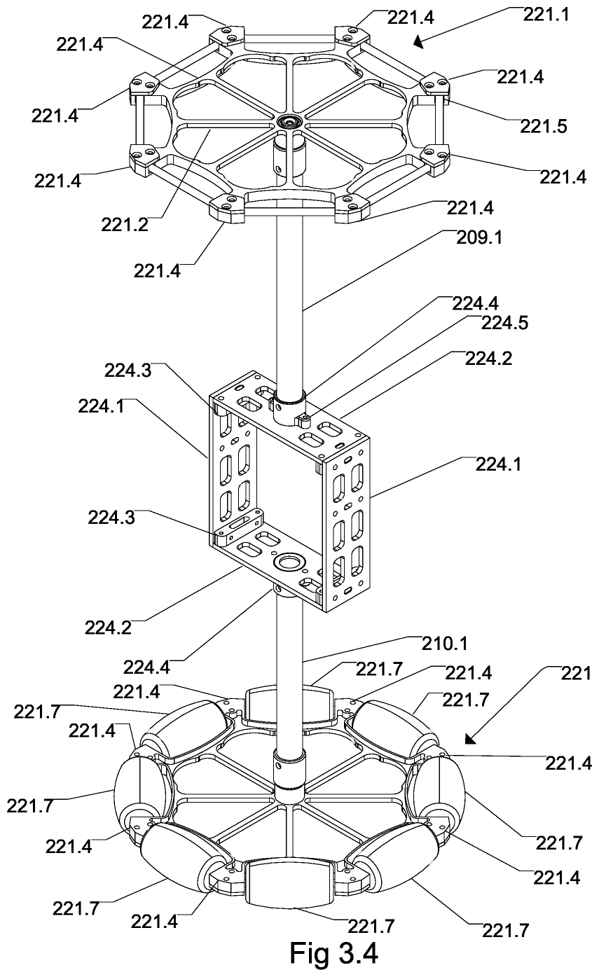

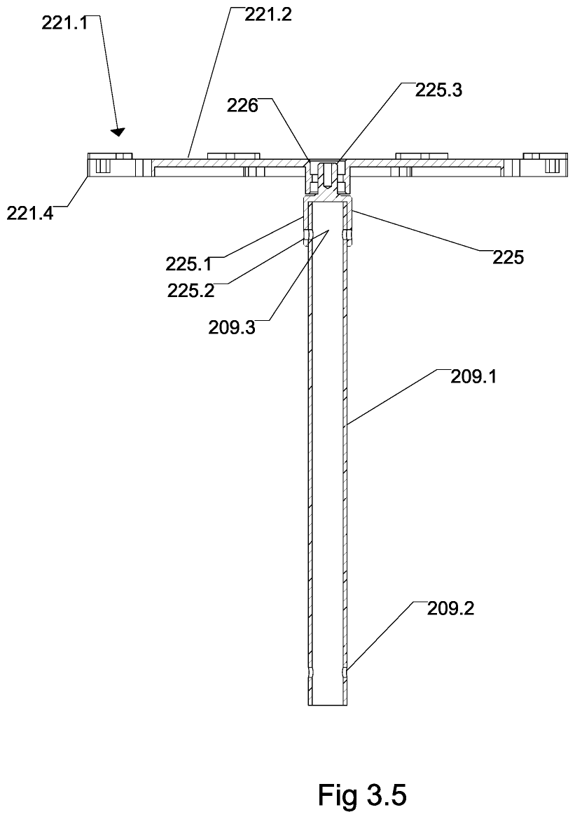

In a second embodiment of the autonomous aerial vehicle shown in FIGS. 2.1 to 2.4 an autonomous aerial vehicle has a thrust body 1 supporting a fender cage 2. The fender cage 2 is formed from elements which in a deployed condition extend to form a perforated spherical surface enveloping the thrust body 1. The fender cage 2 is constructed to be reversibly compactible for packaging, transport and access to the thrust body.

### Second Embodiment

The fender cage of the second embodiment is formed from elements comprising a pair of rigid hollow hemispherical bodies 201, 202 with similar radii. As shown in the figures the first lower hemispherical body 201 has a rim ring 203 on which is formed an external screw thread 204 and a shoulder abutment 205. The second hemispherical body 202 has a rim ring 206 formed with an internal screw thread 207 complementary to the external thread 204 whereby the first and second hemispherical bodies 201, 202 can be united together around the thrust body 1 to form a hollow sphere around the thrust body. By reversing the uniting process the elements of the fender cage can be separated and nested for compact transportation.

In order to achieve the desired rigidity of the fender cage 2 each part 201, 202 may be formed from a web of elongate elements 201.1, 202.1 which are moulded around or into a hemispherical mould or, injection moulded into the hemispherical shape shown so that the joint of each element 201.1, 202.1 with any other intersecting element is stiff, whereby the fender cage tends to retain its shape. Furthermore the interior surfaces of each element and hence the cage follow the surface of a sphere as closely as possible to provide a bearing surface interrupted by passageways. The passageways permit a flow of air through the fender cage in any direction.

A fender cage support assembly includes at least a pair of spokes 209, 210 extend one each from a respective mounting assembly 211, 212 provided on the thrust body 1. In this variant the spokes 209, 210 extend parallel to the thrust axis of the rotors 5 and in diametrically opposite directions (down and up as illustrated). In a variant of the second embodiment (not illustrated) the spokes can extend from the thrust body 1 in a plane substantially perpendicular to the thrust axis. The thrust body 1 has, in these variants a fore aft asymmetry which is determined by the mounting of a camera 213 on the front of the thrust body 1. Spokes disposed substantially perpendicular to the thrust plane may extend laterally and or fore and aft or in any substantially or effectively diametric disposition between these extremes. Where vertical spokes are employed they need not be perfectly parallel to the thrust axis but may be inclined so long as they sufficiently span the radius from the thrust body to the fender cage. In general two diametrically opposed spokes are preferred for simplicity of construction and minimal weight. However, any combination of spoke dispositions is possible so long as the arrangement suspends the thrust body substantially centrally in the fender cage.

The spokes 209, 210 are similarly constructed and interchangeable to minimise construction costs. Each spoke 209, 210 is provided by solid “L” uniform cross section beam having a first major web 214 stiffened by a second web 215 perpendicular to the first. I section or T section beams are also possibilities in variants. In the illustrated second embodiment a third web 216 extends around the spoke end coupled to the thrust body 1. The third web 216 engages between a pair of opposing “L” section jaws 217 forming a clamp structure on the mounting assembly 211, 212. The clamp structure is supported onto the thrust body by means of a rotary bearing 218 allowing the clamp structure and spoke 210 to rotate freely around the long axis of the spoke.

In a variant of the spoke the first web may be formed as a truss to minimise weight and maximise strength.

The end of each spoke remote from the third web 216 is provided with a cylindrical spigot 219. The spigot 219 is received into a sleeve 220 integrally formed on a radially inner surface of a thrust bearing 221.

Each of the two oppositely disposed thrust bearings 221 is provided by a convex disk with an outer spherical surface with a radius of curvature similar to the radius of curvature of the inner surface of the spherical fender cage 2. Each of the inner surface of the fender cage and the spherical outer surface of the thrust bearing 221 are formed to be free of protrusion or obstructions so that the thrust bearing can slide freely over the surface. This may be further facilitated by the use of low friction materials in the fabrication of the fender cage parts and the thrust bearing. In some variants the inner surface of the fender cage and/or the contacting outer surface of the thrust bearing may be provided by a low friction coating or membrane. The disk is perforated by apertures to facilitate the flow of air through the thrust bearing and fender cage.

The spherical fender cage is formed with numerous apertures 222 to facilitate the flow of air into and out of the cage as it is impelled by the thrusters. The apertures may be homogeneously distributed over the surface of the fender cage to avoid adversely influencing the thrust from the thrusters. In the variant shown the apertures are curvilinear squares lying on the surface of the sphere. This allows the material of the fender cage to be formed from elements 223 with a high aspect ratio, ie circumferential area of the aperture is much larger than the circumferential area of material of the fender cage.

Each thrust bearing is formed with numerous apertures to allow the uninhibited through flow of air in order to ensure the predictable direction of thrust from the thrusters.

### Third Embodiment

The third embodiment has a thrust body 1 and fender cage 2 generally similar to the second embodiment. A fender cage support assembly comprises a box section structure 224 formed from opposing upright side members 224.1, joined and spaced by two spaced opposing horizontal members 224.2. The side and horizontal members 224.1, 224.2 are perforated to reduce weight and provide points for securing the box section structure 224 to the lifting body using machine screws and brackets 224.3. A spoke mounting socket 224.4 is mounted centrally one each on each of the horizontal members 224.2. Each spoke mounting socket 224.4 is a cylindrical tube moulded to provide mounting brackets 224.5 to receive screws for attachment to the horizontal member. Diametrically opposed holes 224.6 are provided so that when a proximal end of a cylindrical spoke 209.1, 210.1 is inserted into the socket 224.4, the end is secured by means of a pin or bolt (not shown) passed through each of holes 224.6 and a corresponding hole 209.2.

Each spoke and thrust bearing assembly is identical except for location and orientation and therefore only one will be described in detail.

The distal end of the spoke 209.1 connects to a spindle structure 225. The spindle structure comprises a cylindrical hollow blind socket 225.1 into which the distal end of the spoke 209.1 is received. The distal end of the spoke 209.1 is secured by passing a pin or bolt (not shown) through holes 209.2, 225.2 formed respectively in the distal end of the spoke and the socket 225.1. The distal end of the spindle socket 225.1 is closed by a structure supporting an axially extending spindle 225.3.

The spindle 225.3 provides a rotary bearing axle for rotary bearing 226. rotary bearing 226 facilitates rotation and retention of a thrust bearing 221.

In the third embodiment the thrust bearing 221 comprises a bearing cage 221.1. The bearing cage 221.1 has a hub with an axial bearing housing provided for rotary bearing 226 whereby the bearing cage 221.1 is mounted onto the spindle 225.3. Eight equiangularly spaced spokes 221.2 extend radially from the hub to support a collar 221.3. The collar 221.3 is shaped like a regular octagon to provide eight sides to the collar. An axle support 221.4 extends radially, one each from each junction between a side of the collar. Each axle support 221.4 provides two axle retaining sockets 221.5. Each axle retaining socket 221.5 is aligned to receive one end of a bearing axle 221.6 extending parallel to a side of the collar so that a ring of eight axles is retained extending around the hub and tangentially to a circle concentric with the spindle 225.3. In order to allow the end of each axle to be captured in its corresponding socket a socket plate 221.6 is removably fastened to the axle support 221.4. Each axle 221.6 rotatably mounts a cylindrical roller 221.7. Each cylindrical roller 221.7 has a tapering spherical cylindrical surface which tapers from a maximum radius at the centre, to a minimum diameter at the axial ends. The cross section of the taper follows an arc.

The surface of each roller 221.7 bears against the internal surface of the fender cage. Because the rollers are free to roll around their mounting axles, and the thrust bearings are free to rotate around their hubs, the fender cage can roll freely in any spherical direction around the centre of the spherical fender cage.

Table of integers

| | |
|---|---|
| 1 | thrust body |
| 2 | fender cage |
| 3 | chassis |
| 4 | motors |
| 5 | rotors |
| 6 | suspension beam |
| 7 | rotary rolling element bearing |
| 8 | bearing housing |
| 9 | inner ring |
| 10 | rollers |
| 11 | axle |
| 12 | outer ring |
| 13 | trunnions |
| 14 | inner hub disc |
| 14.1 | threaded central hole |
| 14.2 | grooves |
| 14.3 | axially extending pin holes |
| 15 | outer hub disk |
| 15.1 | central hole |
| 15.2 | grooves |
| 15.3 | axially extending pin holes |
| 16 | machine screw |
| 16.1 | machine screw axial bore |
| 17 | spars |
| 17.1 | spar pin holes |
| 18 | cylindrical pin |
| 19 | struts |
| 19.1 | strut pins |
| 209 | spoke |
| 209.1 | cylindrical spoke |
| 209.2 | hole |
| 209.3 | holes |
| 210 | spoke |
| 210.1 | cylindrical spoke |
| 211 | mounting assembly |
| 212 | mounting assembly |
| 213 | camera |
| 214 | first major web |
| 215 | second web |
| 216 | third web |
| 217 | L-section jaws |
| 218 | rotary bearing |
| 219 | cylindrical spigot |
| 220 | sleeve |
| 221 | thrust bearing |
| 221.1 | bearing cage |
| 221.2 | spokes |
| 221.3 | collar |
| 221.4 | axle support |
| 221.5 | axle retaining socket |
| 221.6 | socket plate |
| 221.7 | rollers |
| 222 | apertures |
| 223 | elements |
| 224 | box section structure |
| 224.1 | side members |
| 224.2 | horizontal members |
| 224.3 | brackets |
| 224.4 | spoke mounting socket |
| 224.5 | mounting bracket |
| 224.6 | holes |
| 225 | spindle structure |
| 225.1 | socket |
| 225.2 | hole |
| 225.3 | spindle |
| 226 | rotary bearing |

1. An autonomous aerial vehicle having:
a thrust body;
spokes extending radially from the thrust body to deploy convex spherical bearing surfaces provided by thrust bearings at a common radius from the thrust body; and
a fender cage having a spherical inner bearing surface with a radius equal to the common radius whereby the fender cage is supported by engagement between the thrust bearings and the inner surface of the fender cage, at a fixed distance from the thrust body and the fender cage can rotate freely in every spherical direction around the thrust body.

2. An autonomous aerial vehicle according to claim 1 wherein the fender cage has elements defining apertures to facilitate the free passage of air in every direction, the thrust bearing surface being sized to always span any of the passageways and engage at least two of the members.

3. An autonomous aerial vehicle according to claim 1 wherein the fender cage is fabricated in two similarly sized hemispherical parts.

4. An autonomous aerial vehicle according to claim 3 wherein the hemispherical parts capable of being separably joined around by means of a rim ring and a rim ring.

5. An autonomous aerial vehicle according to claim 4 wherein each rim ring bears a complementary screw thread.

6. An autonomous aerial vehicle according to claim 1 wherein the each thrust bearing comprises a disk.

7. An autonomous aerial vehicle according to claim 6 wherein the disk is concave.

8. An autonomous aerial vehicle according to claim 7 wherein the disk is perforated by apertures to facilitate the flow of air.

9. An autonomous aerial vehicle according to claim 1 wherein one of said thrust bearing or said spoke presents a spigot and the other a sleeve whereby the thrust bearing is attached to the spoke by receiving the spigot into the sleeve.

10. An autonomous aerial vehicle according to claim 1 wherein the thrust bearings are fabricated from a friction reducing material.

11. An autonomous aerial vehicle according to claim 1 wherein the thrust bearing is provided with friction reducing elements.

12. An autonomous aerial vehicle according to claim 1 wherein the thrust bearing is provided with rolling elements.

13. An autonomous aerial vehicle according to claim 12 wherein the thrust bearing provides a cage supporting the rolling elements for rotation around axis perpendicular to radii of the thrust bearing.

14. An autonomous aerial vehicle according to one of claim 12 wherein the thrust bearing is mounted for rotation around the axis of the spoke.
